(19) United States
(12) Patent Application Publication
(10) Pub. No.: US 2007/0165245 A1
(43) Pub. Date: Jul. 19, 2007

(54) DEVICE AND METHOD FOR THREE-DIMENSIONAL OPTICAL MEASUREMENT

(76) Inventors: Mladen Gomercic, Braunschweig (DE); Detlef Winter, Vordorf (DE); Sebastian Reiss, Vechelde (DE)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/616,425

(22) Filed: Dec. 27, 2006

(30) Foreign Application Priority Data
Jan. 13, 2006 (DE) 102006002077.4-54

(51) Int. Cl. G01B 11/24

(52) U.S. Cl. 356/603

(57) ABSTRACT

The device 1 is described for three-dimensional optical measurement of objects 2 using a topometric measurement method, in which images of projection patterns which have been projected onto an object 2 are recorded and evaluated. The device 1 has a projector 3 with a light source, an image recording unit 5 and an image evaluation unit 6. The light source for the projector 3 is an arc lamp 4, and the image recording unit 5 is designed for synchronization of image recording with the light intensity of the arc lamp 4.

The invention relates to a device for three-dimensional optical measurement of objects using a topometric measurement method, in which images of projection patterns which have been projected onto an object are recorded and evaluated, with the device having a projector with a light source, an image recording unit and an image evaluation unit.

The invention also relates to a method for three-dimensional optical measurement of objects using a topometric measurement method, in which images of projection patterns which have been projected onto an object by a projector are recorded by an image recording unit and evaluated by an image evaluation unit.

Three-dimensional optical detection of object surfaces by means of optical triangulation sensors based on the topometry principle is sufficiently well known. In this case, by way of example, different strip patterns are projected onto the object to be measured, are observed by one or more cameras and are then evaluated with computer assistance. The evaluation methods are, for example, the phase-shifting method, coded light attachment or the heterodyne method.

The principles and practical application of topometric measurement methods such as these are described in detail, for example, in “Bildverarbeitung und Optische Meastechnik in der Industriellen Praxis”[Image Processing and Optical Metrology in Industrial Practice], 1993, Franzis-Verlag GmbH, Munich.

Various apparatuses by means of which such test layouts can be implemented are described in Reinhard W. Matz: “Codierte Lichtstukturen für 3-D-Messtechnik und Inspektion” [Coded Light Structures for 3-D Metrology and Inspection], Berichte aus dem Institute für Technische Optik der Universitat Stuttgart [Reports from the Institute of Technical Optics at Stuttgart University], January 1992.

The quality of the measurement results from the three-dimensional optical measurement of objects by means of strip projection is highly dependent on the contrast between the projection and the surrounding light.

The object of the present invention is thus to provide an improved device for three-dimensional optical measurement of objects using a topometric measurement method which has a projector with a relatively high light intensity in order to achieve better contrast conditions.

The object is achieved by the device of the type mentioned initially, in that the light source for the projector is an arc lamp, and the image recording unit is designed for synchronization of image recording and/or image evaluation with the light intensity of the arc lamp.

The use of a projector with an arc lamp makes it possible to considerably increase the light intensity in comparison to conventional projectors, and to improve the measurement accuracy. In some circumstances, this is the first time which it has been at all possible to carry out topometric measurements in corresponding environmental conditions.

Arc lamps have been known per se for a long time and are used, for example, in cinema projectors or headlights (flood lights, lighthouses). They have a very high efficiency and thus allow high light yields.

Because of their small, bright light spot (arc), they have particularly good focusing characteristics, so that they are particularly suitable for use in projectors.

Arc lamps such as these hare the disadvantage that they must be regulated. The two electrodes of the arc lamp have their polarities reversed continuously, for example at 50 to 200 Hz. The measurement methods which are used for three-dimensional optical measurement of objects using a topometric measurement method, such as the phase-shifting method, require, however, that the light intensity of the projector does not change, at least between two individual images during a measurement. Depending on how many such polarity reversals now occur in the exposure time, this can lead to brightness fluctuations from one image to the next.

In addition, in some cases, the arc jumps in an uncontrolled manner at unpredictable times. This arc jumping leads to unpredictable fluctuations in the overall brightness and brightness distribution of the emitted light.

EP 0 766 906 B1 discloses a method for avoidance of the uncontrolled arc jumping effect and of the uncontrollable changes in the brightness associated with it, by operating the arc lamp using an alternating current, which has an additional pulse shortly before commutation.

This additional current pulse once again produces a light pulse, as a result of which even arc lamps as described with this method may have brightness fluctuations in the image. Different numbers of light pulses can occur during the exposure time of an individual image recording depending on where the exposure time starts in the current intensity diagram, that is to say in the current waveform of the arc lamp, over time, and where it ends. In consequence, in some circumstances, the uniformity of the illumination intensity of two individual images in a measurement is not ensured.

It is thus proposed that the image recording be synchronized with the light intensity of the arc lamp. This for the first time makes it sensibly possible to use an arc lamp in a worthwhile manner as a projector for topometric measurements.

Any lamps of adequate brightness can thus be considered for use as arc lamps which can be used for the invention and for the purposes of the invention, in which the problem of brightness fluctuations exists and which allow the problem to be solved by synchronization of the image recording and/or image evaluation. In particular, these are lamps with non-constant brightness profiles which recur cyclically.

The synchronization can be carried out by triggering of the exposure time of the image recording unit as a function of the brightness profile of the arc lamp. This means that the image recording is synchronized as a function of a trigger signal of the arc lamp. The trigger signal may be transmitted electrically or optically.

However, conversely, the triggering can be provided by controlling the current waveform of the arc lamp over time by means of a trigger signal of the image recording unit such that the image recording unit sets a defined brightness for the arc lamp at the time of image recording.

However, it is also feasible for both the arc lamp and the image recording unit to be synchronized to one another by means of an external trigger signal.

Quasi-synchronization of image evaluation is also possible. The light fluctuations that occur and whose effect has in some circumstances not been compensated for by synchronization of image recording can be compensated for mathematically on the basis of known image recording times and light intensity profiles. The respective (unsynchronized) position of the exposure time in the intensity profile of the lamp can be recorded for this purpose.

A further object of the invention is to provide an improved method for three-dimensional optical measurement of objects.

The object is achieved by a method of the type mentioned in the introduction by synchronization of image recording and/or image evaluation with the light intensity of an arc lamp in the projector.

The method and the corresponding device ensure that the light intensity curve of the arc lamp always passes through the same curve components in the exposure times of successive image records, so that, for example, there are always precisely the same number of peaks or light intensity peaks, per image.

The start time is in this case defined, for example, by triggering of the exposure time of the camera which is used for observation of the projected light structures, by means of the arc lamp.

It is particularly advantageous if the image evaluation unit is designed for mathematical compensation for changes in the light intensity in successive image records as a function of the previously recorded image recording time in the light intensity profile over time. This makes it possible to compensate the changes in the light intensity, using the known position of the exposure time in the light intensity curve.

The invention will be explained in more detail in the following text using the attached drawings, by way of example, in which:

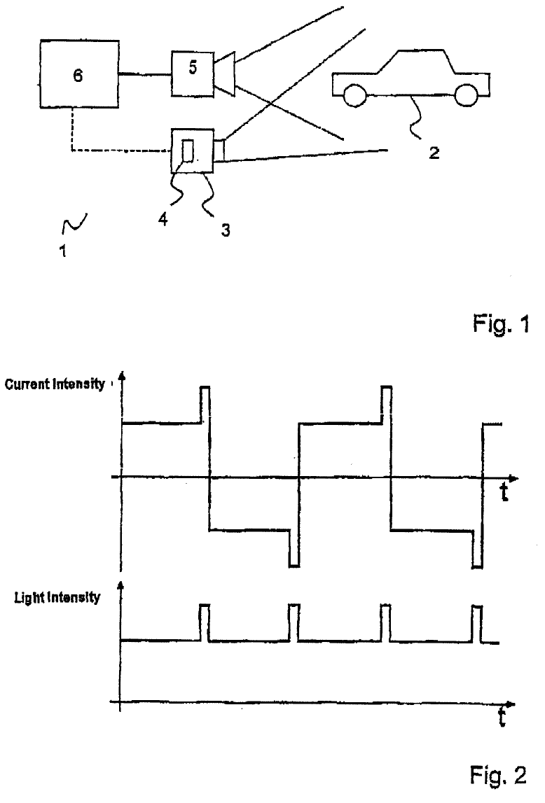

FIG. 1 shows a sketch of a device for three-dimensional optical measurement of objects;

FIG. 2 shows a schematic current waveform/light intensity profile of an arc lamp with a square-wave current waveform with an additional pulse shortly before commutation;

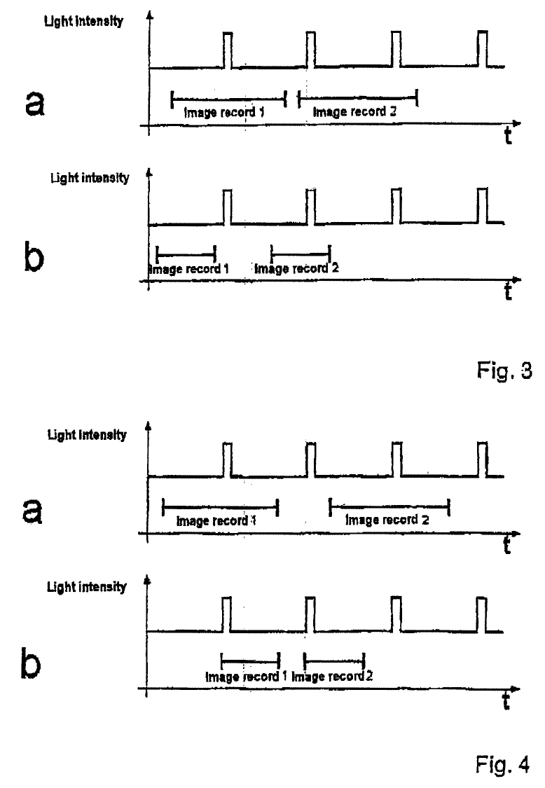

FIG. 3 shows a schematic illustration of the light intensity profile and of the image recording with an untriggered illumination time for different exposure times; and

FIG. 4 shows a schematic illustration of the light intensity profile and of the image recording with a triggered illumination time for different exposure times.

FIG. 1 shows a schematic illustration of a device 1 for three-dimensional optical measurement of objects 2 using a topometric measurement method. The device 1 has a projector 3 with an arc lamp 4 for projection of the selected projection patterns onto the object 2. The arc lamp 4 results in a relatively high light intensity and thus a contrast ratio which is better than that of conventional measurement methods. By way of example, a metal-vapor lamp or the like can be used as the arc lamp 4.

Furthermore, an image recording unit 5 is provided in a manner known per se in the form of at least one camera, which points at the object 2 and is designed to record images of the object with projection patterns projected onto it. The image recording unit 5 is connected to an image evaluation unit 6 in order to evaluate the recorded images for topometric measurement of the object 2.

The image evaluation unit 6 may, for example, be a suitably programmed computer. The methods for topometric image evaluation are sufficiently well known and will not be explained any further,

The use of an arc lamp 4 for the projector 3 results in the problem of the light intensity of the projector 3 varying during a measurement.

The light intensity of the projector 3 and the image recording unit 5 are thus synchronized to one another so that the brightness profiles of successive image records are comparable to one another and are preferably identical.

FIG. 2 shows a graph of the current intensity waveform of an arc lamp 4 over time. The current waveform is virtually a square-wave. An additional pulse is applied shortly before commutation, that is to say the reversal of the current-flow direction. This leads to an approximately constant light intensity profile with corresponding pulse peaks.

FIG. 3a shows the light intensity profile over time, and two successive image records 1 and 2 in the illustrated time periods. This clearly shows a light intensity pulse or peak in the time period of the image record 1, and two peaks in the time period of the image record 2. The light intensity is thus different in the two successive images.

FIG. 3b shows a light intensity profile likewise with two image records, over time. This clearly shows that there is no light intensity pulse or peak in the time period of the first image record 1, while there is one peak in the time period of the second image record 2. In this case as well, the light intensity for the two successive image records is different.

FIG. 4a shows an illustration of the light intensity profile over time, once again with two successive image records. However, the image recording is now synchronized with the light intensity of the arc lamp by matching the exposure times of the individual image records and the start times of image recording to the light intensity profile over time.

This clearly shows that there is one peak in each time period in each of the two image records 1 and 2. The light intensities of the individual image records are thus comparable with one another.

FIG. 4b shows a graph of the light intensity profile over time with two image records 1 and 2. In this case, image recording starts at the same time as the pulse, which is applied before commutation in the current waveform of the arc lamp 4. The time duration of the individual image records is in this case chosen such that the image recording is in each case completed before the occurrence of the subsequent commutation.

For example, synchronization is thus carried out using the current pulse which is applied to the current waveform of the arc lamp before commutation.

1. A device (1) for three-dimensional optical measurement of objects (2) using a topometric measurement method, in which images of projection patterns which have been projected onto an object (2) are recorded and evaluated, with the device having a projector (3) with a light source, an image recording unit (5) and an image evaluation unit (6), wherein, the light source for the projector (3) is an arc lamp (4), and the image recording unit (5) is designed for synchronization of image recording and/or of the image evaluation unit with the light intensity of the arc lamp (4).

2. The device (1) as claimed in claim 1, wherein the image recording unit (5) is designed for synchronization of image recording as a function of a trigger signal of the arc lamp (4).

3. The device (1) as claimed in claim 1, wherein the image recording unit (5) and the projector (3) are electrically connected to one another and are designed for synchronization by triggering of the current waveform of the arc lamp (4) over time by means of a trigger signal of the image recording unit (5).

4. The device (1) as claimed in claim 1, wherein the arc lamp (4) and the image recording unit (5) are designed for synchronization with an external trigger signal.

5. The device (1) as claimed in claim 1, characterized in that the image evaluation unit (6) is designed for mathematical compensation for changes in the light intensity as a function of the previously recorded image recording time in the known light intensity profile over time.

6. The device (1) as claimed in claim 1, characterized in that the image recording unit (5) comprises at least one camera.

7. A method for three-dimensional optical measurement of objects using a topometric measurement method, in which images of projection patterns which have been projected onto an object (2) by a projector (3) are recorded by an image recording unit (5) and are evaluated by an image evaluation unit (6), comprising synchronization of image recording and/or image evaluation with the light intensity of an arc lamp (4) of the projector (3).

8. The method as claimed in claim 7, comprising synchronization of image recording as a function of a trigger signal of the arc lamp (4).

9. The method as claimed in claim 7 comprising synchronization of image recording by triggering of the cur-rent waveform of the arc lamp (4) over time by means of a trigger signal of the image recording unit (5).

10. The method as claimed in claim 7, comprising synchronization of the image recording unit (5) with the light intensity of the arc lamp (4) as a function of an external trigger signal for the image recording unit (5) and the projector (3).

11. The method as claimed in claim 7, comprising mathematical compensation for changes in the light intensity as a function of the previously recorded image recording time in the known light intensity profile over time.
